(19) United States
(12) Patent Application Publication
(10) Pub. No.: US 2018/0293880 A1
(43) Pub. Date: Oct. 11, 2018

(54) WIRELESS REMOTE CONTROL RETROFIT KIT

(71) Applicant: Snow EZ, LLC, Avon, CT (US)

(72) Inventors: Gene Paul Congilaro, Fairport, NY (US); Robert Finley Hyde, Weatogue, CT (US)

(21) Appl. No.: 15/482,134

(22) Filed: Apr. 7, 2017

(51) Int. Cl. G08C 17/02; H04W 4/00; B60R 16/023

(52) U.S. Cl. CPC G08C 17/02; G08C 2201/50; B60R 16/023; H04W 4/008

(57) ABSTRACT

The present application provides a remote control kit for retrofitting controllers for multiple types and brands of vehicle-mounted apparatus (e.g., snow plows and salt spreaders) for wireless control. The kit includes a remote control with a plurality of input elements for controlling the operation of a vehicle-mounted apparatus and a wireless transmitter. The kit further includes an apparatus communicator with a wireless receiver for receiving wireless signals corresponding to different apparatus operations from the wireless transmitter of the remote control. The apparatus communicator connects to the controller of the vehicle-mounted apparatus so that control signals can be transmitted to the controller of the vehicle-mounted apparatus to execute desired apparatus operations.

### TECHNICAL FIELD

The present application relates to remote control kits for retrofitting controllers for vehicle-mounted apparatus (e.g., snow plows and salt distributors) for wireless control.

### BACKGROUND

Controllers may be used to control the movement and function of operable machinery, such as a snowplow or salt distributor mounted to a motor vehicle. Conventional controllers of snowplows mounted to vehicles are connected by one or more wires running from the snowplow to an interior cabin of the motor vehicle so that the controller is within reach of a user. However, such wired arrangements may present drawbacks. For instance, controller placement within the motor vehicle cabin is constrained by having the controller tethered, which is inconvenient for users. Further, the presence of the one or more wires connected to the controller can be an annoying obstacle for the user during use or even during non-use of the controller.

### SUMMARY

According to one embodiment of the present application, a remote control retrofit kit for controlling a vehicle-mounted apparatus, comprises: a remote control comprising a plurality of input elements for controlling the operation of the vehicle-mounted apparatus and a wireless transmitter; and an apparatus communicator comprising a wireless receiver and a first cord with a first connector configured to connect to an OEM wiring harness of a controller of the vehicle-mounted apparatus; wherein the wireless receiver of the apparatus communicator receives wireless signals corresponding to different apparatus operations from the wireless transmitter of the remote control and sends control signals to the controller of the vehicle-mounted apparatus to execute desired apparatus operations.

According to another embodiment of the present application, a remote control retrofit kit for controlling multiple vehicle-mounted apparatuses, comprises: a remote control comprising a plurality of input elements for controlling the operation of the vehicle-mounted apparatus, a rechargeable battery, a power input and a wireless transmitter; a remote control charger comprising a first power connector configured to be inserted into an electrical power receptacle in the vehicle and a second power connector configured to connect to the power input of the remote control for charging the rechargeable battery; a first apparatus communicator comprising a first wireless receiver and a first cord with a first connector configured to connect to a first OEM wiring harness of a first controller of a first vehicle-mounted apparatus; wherein the first wireless receiver of the first apparatus communicator receives wireless signals corresponding to different apparatus operations from the wireless transmitter of the remote control and sends control signals to the first controller of the first vehicle-mounted apparatus to execute desired apparatus operations; and a second apparatus communicator comprising a second wireless receiver and a second cord with a second connector configured to connect to a second OEM wiring harness of a second controller of a second vehicle-mounted apparatus; wherein the second wireless receiver of the second apparatus communicator receives wireless signals corresponding to different apparatus operations from the wireless transmitter of the remote control and sends control signals to the second controller of the second vehicle-mounted apparatus to execute desired apparatus operations.

According to another embodiment of the present application, a remote control retrofit kit for controlling a vehicle-mounted apparatus, comprises: a remote control comprising a plurality of input elements for controlling the operation of the vehicle-mounted apparatus and a wireless transmitter; a remote control charger comprising a first power connector configured to be inserted into an electrical power receptacle in the vehicle and a second power connector configured to connect to the power input of the remote control for charging the rechargeable battery; an apparatus communicator comprising a wireless receiver and a first cord with a first connector; and a wiring harness adapter having a second cord with a plurality of wires, a second connector on one end of the cord and a plurality of third connectors attached to the plurality of wires on the other end of the second cord; wherein the second connector of the wiring harness adapter is configured to mate and connect with the first connector of the apparatus communicator; wherein the plurality of third connectors of the wiring harness adapter are configured to connect directly with a controller of the vehicle-mounted apparatus; and wherein the wireless receiver of the apparatus communicator receives wireless signals corresponding to different apparatus operations from the wireless transmitter of the remote control and sends control signals to the controller of the vehicle-mounted apparatus to execute desired apparatus operations.

### BRIEF DESCRIPTION OF THE DRAWINGS

FIG. 1 shows an exemplary remote control retrofit kit;

FIG. 2 shows a schematic diagram of an exemplary remote control of the remote control retrofit kit of FIG. 1;

FIG. 3 shows a schematic diagram of an exemplary apparatus communicator of the remote control retrofit kit of FIG. 1;

FIG. 4 shows a motor vehicle outfitted with the remote control retrofit kit of FIG. 1;

FIG. 5 shows a wiring harness adapter for use with the remote control retrofit kit of FIG. 1;

FIGS. 6A and 6B show different embodiments of a remote control charger; and

FIG. 7 shows another embodiment of a remote control charger.

### DETAILED DESCRIPTION

Before the various embodiments are described in further detail, it is to be understood that the invention is not limited to the particular embodiments described. It will be understood by one of ordinary skill in the art that the devices described herein may be adapted and modified as appropriate for the application being addressed and that the devices described herein may be employed in other suitable applications, and that such other additions and modifications will not depart from the scope thereof.

In the drawings, like reference numerals refer to like features of the systems and methods of the present application. Accordingly, although certain descriptions may refer only to certain Figures and reference numerals, it should be understood that such descriptions might be equally applicable to like reference numerals in other Figures.

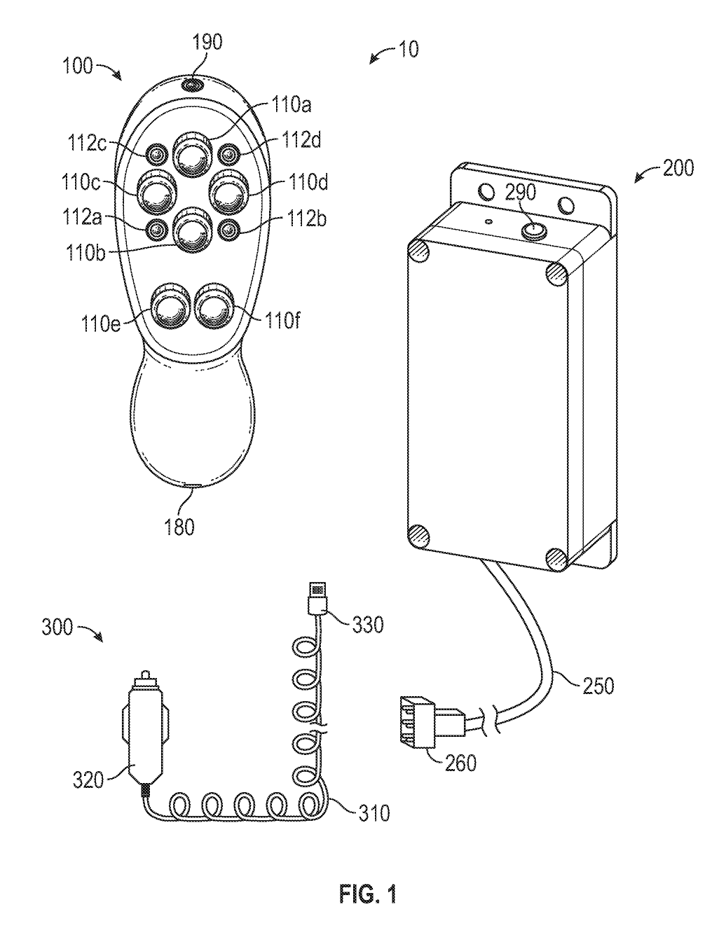

The present application provides a remote control kit for retrofitting controllers for multiple types and brands of vehicle-mounted apparatus (e.g., snow plows and salt spreaders) for wireless control. FIG. 1 shows an exemplary embodiment of a remote control retrofit kit (“RCRK”) 10. RCRK 10 comprises a remote control 100, apparatus communicator 200, and remote-control charger 300. Remote control 100 comprises a number of input elements (e.g., buttons) for controlling the operation of a vehicle-mounted apparatus, such as a snowplow or salt spreader. Remote control 100 wireless communicates with apparatus communicator 200, which is operatively connected to a vehicle-mounted apparatus. Apparatus communicator 200 receives wireless signals corresponding to different apparatus operations from remote control 100 and sends control signals to a controller of the vehicle-mounted apparatus to execute a desired apparatus operation. Remote-control charger 300 is configured to connect to a vehicle electrical power receptacle (e.g., 12V DC power cigarette lighter receptacle, 5V USB receptacle) for charging remote control 100.

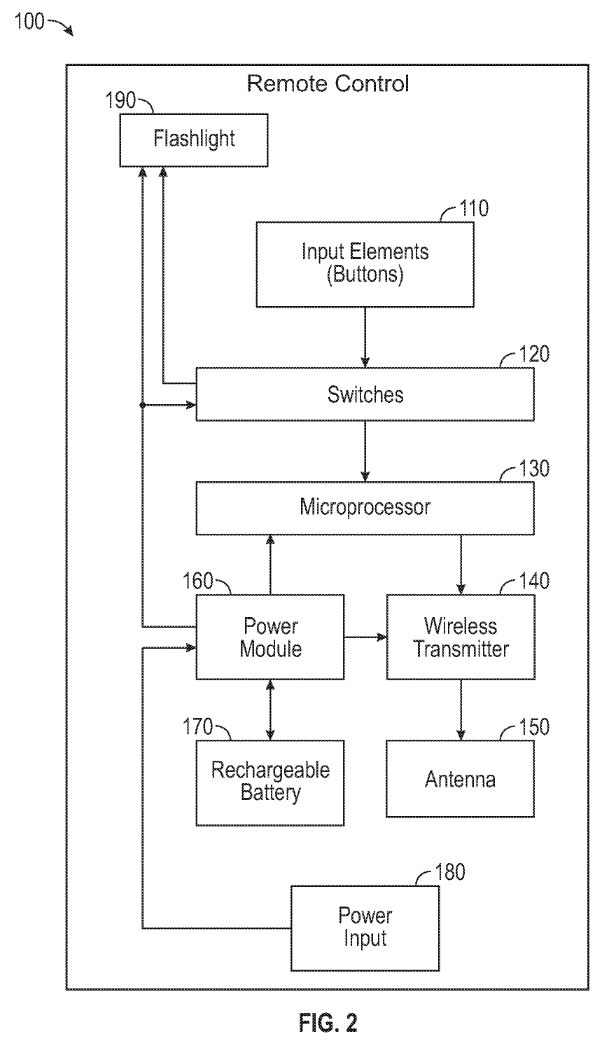

FIG. 2 shows a schematic diagram of an exemplary embodiment of remote control 100. Remote control 100 is ergonomically designed to fit comfortably is a user's hand and to be easily manipulated by a user. Further, remote control 100 preferably has a waterproof and shockproof ABS plastic case. Remote control 100 comprises a plurality of input elements 110, a plurality of indicator lights 112, electrical switches 120, microprocessor 130, wireless transmitter 140 and antenna 150.

The plurality of input elements 110 (e.g., buttons) correspond to a plurality of apparatus operations. For example, as shown in the embodiment of FIG. 1, the plurality of input elements 110 may be configured to operate a straight blade snow plow (e.g., raise, lower, pivot left, pivot right) and/or to operate a salt spreader (e.g., ON and OFF). In the embodiment of FIG. 1, button 110a may be used to raise a snow plow, button 110b may be used to lower the snow plow, button 110c may be used to pivot the snow plow to the left, button 110d may be used to pivot the snow plow to the right, button 110e may be used to turn an integrated flashlight 190 ON and OFF, and button 110f may used to check the charge of rechargeable battery 170. Alternatively, if remote control 100 is configured to control both a snow plow and a salt spreader, input elements 110 may be assigned different functions. For example, button 110e may be used to turn an integrated flashlight 190 ON and also to simultaneously check the charge of rechargeable battery 170, and button 110f may be used to turn the salt spreader ON and OFF.

The plurality of indicator lights 112 may be used to indicate the status of different remote control 100 functions. As shown in the embodiment of FIG. 1, remote control 100 may be provided with different color LED lights 112a, 112b, 112c and 112d. For example, lights 112a and 112b may be used to indicate the charge of rechargeable battery 170 when a button 110 is actuated to do a battery check. In one embodiment, light 112a may be a red light that indicates that rechargeable battery 170 has no charge and light 112b may be a green light that indicates that rechargeable battery 170 is charged. Further, both red light 112a and green light 112b may be simultaneously lit to indicate that rechargeable battery 170 needs to be charged. Also, light 112c may be a yellow light used to indicate that an input element 110 has been activated and a wireless signal is being transmitted. Further, light 112d may be a blue light used to indicate that remote control 100 is connected to charger 300 and recharging rechargeable battery 170.

In other embodiments (not shown), input elements 110 may be configured to perform different apparatus operations depending on the types of apparatus that remote control 100 is configured to control. For instance, remote control 100 may be configured with greater or fewer input elements 110 corresponding to a different number of apparatus operations. For example, remote control 100 may instead be configured to control a V plow. Accordingly, instead of having input elements 110 corresponding to pivot left and pivot right operations, remote control 100 may instead include input elements 110 for controlling each of the left and right blades of the V plow individually between a forward position, a middle position and a backward position. Also, remote control 100 may include additional input elements 110 for controlling other salt spreader functions, such as engine choke, engine start, conveyor, spinner, vibrator, reverse operation for clearing jams, etc.) Further, remote control 100 may be switched to operate in a combination mode where microprocessor 130 is configured to automatically coordinate certain apparatus operations. For example, microprocessor 130 may be configured to automatically turn ON the salt spreader when the plow is lowered, and to automatically turn OFF the salt spreader when the plow is raised.

The plurality of input elements 110 (e.g., mechanical buttons, thermally-sensitive keypad, pressure-sensitive keypad, etc.) are operatively connected to a plurality of electrical switches 120, so that when a user activates an input element 110, a corresponding electrical switch 120 is actuated to generate an electrical signal corresponding to the apparatus operation of the input element 110 activated by the user. Electrical switches 120 may be electromechanical relays (EMRs) or solid-state relays (SSRs). Further, electrical switches 120 may be momentary switches or maintained switches, depending on the apparatus operation/function which they are assigned. Microprocessor 130 is connected to electrical switches 120 to receive electrical signals generated by electrical switches 120 and generate wireless signals corresponding to the apparatus operations of the input elements 110 activated by the user. Microprocessor 130 is connected to wireless transmitter 140, which is connected to antenna 150. Microprocessor 130 controls wireless transmitter 140 to send the generated wireless signals via antenna 150. Microprocessor 130 and wireless transmitter 140 are configured to send wireless signals via any suitable wireless communication protocol, such as, for example, BLUETOOTH®, WI-FI®, ZIGBEE®, but preferably, short-range unlicensed radio-frequency (RF) bands.

Further, as shown in FIG. 2, remote control 100 comprises power module 160, rechargeable battery 170 and power input 180. Power module 160 is connected to rechargeable battery 170 and comprises electrical circuitry for supplying power to electrical switches 120, microprocessor 130 and wireless transmitter 140 from rechargeable battery 170. Further, power module 160 is connected to power input 180, which is connectable to an external power source. The electrical circuitry of power module 160 is configured to recharge battery 170 with power when an external power source is connected to power input 180. Also, if battery 170 has no charge, an external power source may be connected to power input 180 to provide the necessary power for operation of remote control 100. Power input 180 may have any suitable configuration, such as, for example, USB port, electrical contacts, etc. Remote control 100 is preferably configured without an ON/OFF power switch, which can drain battery power if left ON. Instead, remote control 100 is operational only when input elements 110 are activated, which improves battery life. Rechargeable battery 170 is preferably a high capacity battery, which can provide up to 25 hours of continuous operation.

In some embodiments, remote control 100 may further comprise an integrated flashlight 190 that can be used illuminate inside or outside the cabin of the vehicle when a user is working in the dark. Also, remote control 100 may further comprise an integrated microphone and a communication module implementing a communication protocol for communicating with a two-way radio (e.g., BLUETOOTH®), so that remote control 100 can be used as a wireless handheld microphone for a two-way radio.

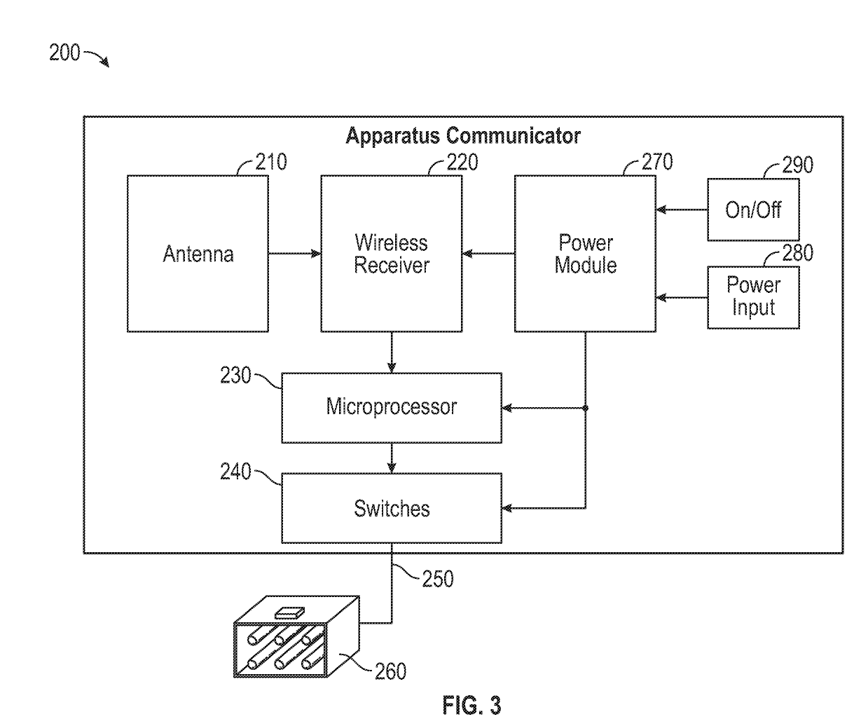

FIG. 3 shows a schematic diagram of an exemplary embodiment of apparatus communicator 200. Apparatus communicator 200 comprises antenna 210, wireless receiver 220, microprocessor 230 and electrical switches 240. Antenna 210 and wireless receiver 220 are configured to receive wireless signals generated by remote control 100 corresponding to the apparatus operations of the input elements 110 activated by the user. Microprocessor 230 is connected to wireless receiver 220 to communicate with microprocessor 130 and wireless transmitter 140 of remote control 100 via a common communication protocol, such as, for example, BLUETOOTH®, WI-FI®, ZIGBEE®, but preferably, short-range unlicensed radio-frequency (RF) bands. For example, remote control 100 and apparatus communicator 200 may communicate using a short-range unlicensed radio-frequency (RF) band such as 315 or 433 megahertz AM, OOK/ASK using sc2262 type coding and transmit i.c., FSK, or the like. Accordingly, there may be up to approximately 100 billion unique codes for pairing remote control 100 with apparatus communicator 200, which allows multiple RCRKs 10 to be configured with unique coding configurations to avoid interference among RCRKs 10 being operated in relatively close range. Thus, multiple RCRKs 10 may operate in the same area, such as a parking lot, without interference.

Microprocessor 230 actuates electrical switches 240 to convert the received wireless signals to electrical control signals for controlling the operation of the vehicle-mounted apparatus in accordance with apparatus operations corresponding to the user-activated input elements 110 of remote control 100. Electrical switches 240 may be electromechanical relays (EMRs) or solid-state relays (SSRs). Further, apparatus communicator 200 is configured to be connected to the vehicle-mounted apparatus so that electrical control signals are sent to the controller of the vehicle-mounted apparatus. As shown if FIG. 3, Apparatus communicator 200 comprises cord 250 and connector 260. One end of cord 250 is connected to electrical switches 240. The other end of cord 250 has connector 260, which is configured to connect to a mating connector on the end of an OEM wiring harness connected to the controller(s) (e.g., solenoid valve, electric motor, etc.) of the vehicle-mounted apparatus. Accordingly, cord 250 and connector 260 are configured to transmit electrical control signals from electrical switches 240 to a controller of the vehicle-mounted apparatus for controlling the operation of the vehicle-mounted apparatus in accordance with apparatus operations corresponding to the user-activated input elements 110 of remote control 100. FIG. 3 shows an embodiment of connector 260 as a 6-pin connector that is configured to mate with a corresponding female connector of an OEM wiring harness of the vehicle-mounted apparatus. However, it should be noted that other types of connectors (e.g., 12-pin connector) may be used depending on the specific vehicle-mounted apparatus being controlled.

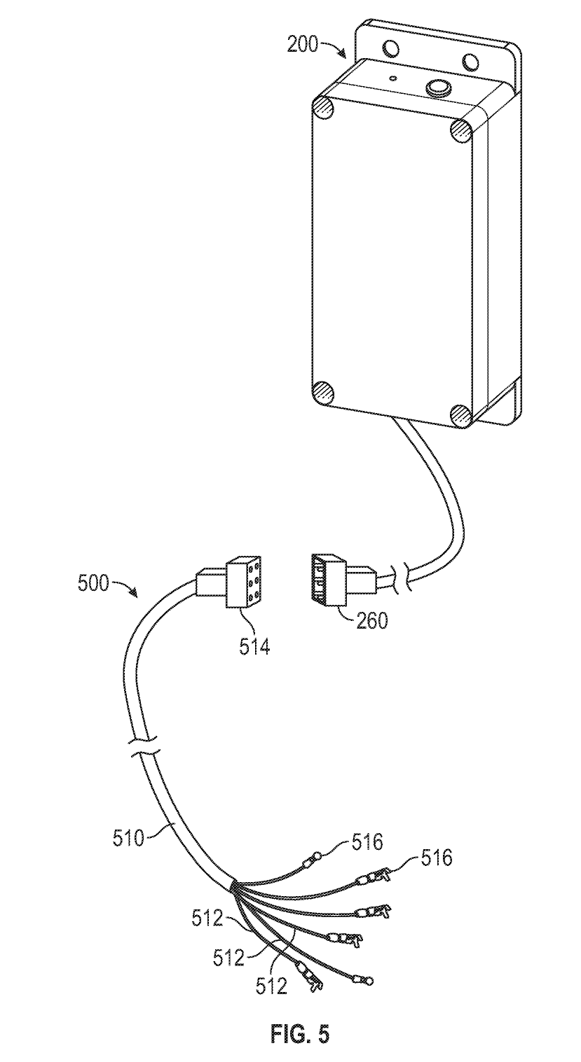

In another embodiment, RCRK 10 may further comprise a wiring harness adapter 500 for installations where an OEM wiring harness for the vehicle-mounted apparatus is not present, or where a wiring harness adapter 500 is necessary to interface apparatus communicator 200 directly with the controller of the vehicle-mounted apparatus and bypass other control components of the vehicle-mounted apparatus. As shown in FIG. 5, wiring harness adapter 500 comprises a cord 510 with a plurality of wires 512, a molded plug 514 on one end of the cord 510 and a plurality of connectors 516 on the other end of the cord 510. Molded plug 514 of wiring harness adapter 500 is configured to mate and connect with connector 260 of apparatus communicator 200. The plurality of connectors 516 attached to the plurality of wires 512 at one end of cord 510 are configured to connect directly with the controller(s) (e.g., solenoid valve, electric motor, etc.) of the vehicle-mounted apparatus. For example, connectors 516 attached to the plurality of wires 512 at one end of cord 510 may be eye-ring connectors, female or male push-on connectors, or other suitable connectors for connecting directly to the controller(s) (e.g., solenoid valve, electric motor, etc.) of the vehicle-mounted apparatus. Accordingly, electrical control signals can be sent to the controller of the vehicle-mounted apparatus via wiring harness adapter 500.

Further, as shown in FIG. 3, apparatus communicator 200 comprises power module 270, power input 280 and ON/OFF switch 290. Power module 270 is connected to power input 280 and comprises electrical circuitry for supplying power to wireless receiver 220, microprocessor 230 and switches 240. Additionally, ON/OFF switch 290 may be connected to power module 270 to turn power to apparatus communicator 200 ON and OFF.

As shown in FIG. 1, an exemplary embodiment of remote-control charger 300 comprises power cord 310 with a first power connector 320 on one end and a second power connector 330 on another end. First power connector 320 is configured to be inserted into a vehicle electrical power receptacle (e.g., 12V DC power cigarette lighter receptacle, 5V USB receptacle). In the embodiment of FIG. 1, first power connector 320 is a cigarette lighter plug adapted to be inserted into a cigarette lighter receptacle in a vehicle. Alternatively, in another embodiment (not shown), first power connector 320 may be a USB plug adapted to be inserted into a USB receptacle in a vehicle. Second power connector 330 is configured to be operatively connected to power input 180 of remote control 100. In the embodiment of FIG. 1, second power connector 330 is a USB plug adapted to be inserted into power input 180 of remote control 100, which is a USB receptacle.

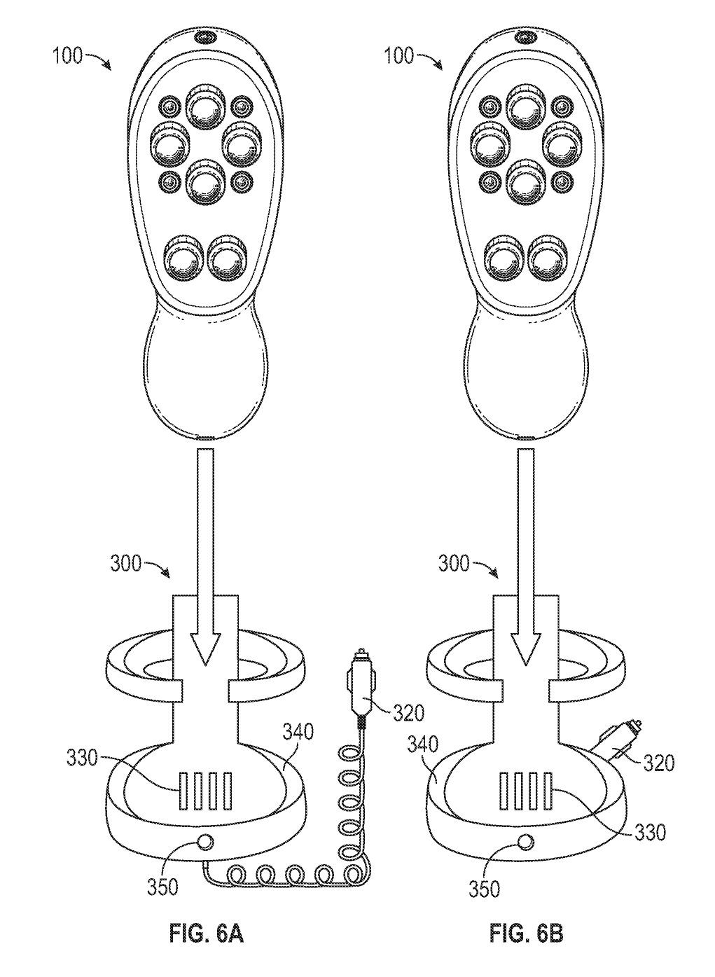

Alternatively, in other embodiments shown in FIGS. 6A and 6B, charger 300 may comprise a drop-in charging cradle 340 where second power connector 330 is integrally provided in charging cradle 340 as electrical contacts that are adapted to abut corresponding electrical contacts of power input 180 of remote control 100 when remote control 100 is seated in the charging cradle 340. Also, a charging indicator light 350 can be provided on charging cradle 340 to indicate that remote control 100 is properly seated in cradle 340 and charging. Accordingly, remote control 100 can be charged by simply dropping remote control 100 into charging cradle 340 of charger 300. In the embodiment of FIG. 6A, charging cradle 340 has power cord 310 extending therefrom with first power connector 320 on the end configured to be inserted into a vehicle electrical power receptacle (e.g., 12V DC power cigarette lighter receptacle, 5V USB receptacle). Accordingly, charging cradle 340 of the embodiment of FIG. 6A can be mounted on a vehicle dash and first power connector 320 at the end of cord 310 can be inserted into a vehicle electrical power receptacle so that power can be provided to second power connector 330 (e.g., electrical contacts) in charging cradle 340. In the embodiment of FIG. 6B, first power connector 320 is integrally provided with charging cradle 340 so that charging cradle is configured to be inserted into a vehicle electrical power receptacle (e.g., 12V DC power cigarette lighter receptacle, 5V USB receptacle). Accordingly, by inserting first power connector 320 into a vehicle electrical power receptacle, power can be provided to second power connector 330 (e.g., electrical contacts) in charging cradle 340.

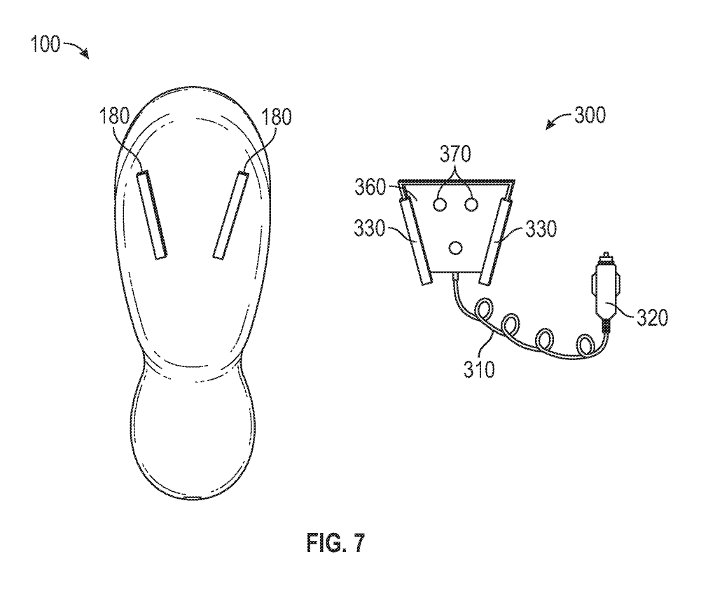

In a further embodiment as shown in FIG. 7, charger 300 may comprise a charging bracket 360 where second power connector 330 is integrally provided in charging bracket 360. For example, as shown in FIG. 7, power connector 330 may be provided as charging extensions comprising electrical contacts that are adapted to be inserted into corresponding recessed charging slots of power input 180 of remote control 100 when remote control 100 is hung on charging bracket 360. Electrical contacts are provided in the recessed charging slots of power input 180 of remote control 100, so that the electrical contacts on the charging extensions of charging bracket 360 abut the electrical contacts of power input 180 of remote control 100 when remote control 100 is hung on charging bracket 360. Accordingly, remote control 100 can be charged by simply hanging remote control 100 onto charging bracket 360 of charger 300. As shown in FIG. 7, charging bracket 360 has power cord 310 extending therefrom with first power connector 320 on the end configured to be inserted into a vehicle electrical power receptacle (e.g., 12V DC power cigarette lighter receptacle, 5V USB receptacle). Accordingly, charging bracket 360 of the embodiment of FIG. 7 can be mounted on a vehicle dash using mounting holes 370 and first power connector 320 at the end of cord 310 can be inserted into a vehicle electrical power receptacle so that power can be provided to second power connector 330 (e.g., electrical contacts) in charging bracket 360.

Although remote-control charger 300 has been described with reference to certain embodiments, it should be understood that remote-control charger 300 and remote control 100 may have any other suitable type of configuration for transmitting power from a power source in the vehicle to remote control 100 to charge rechargeable battery 170 and to provide necessary power for operation of remote control 100 if battery 170 has no charge.

RCRK 10 has been described with respect to the operation of vehicle-mounted apparatus, such as, for example, snowplows and salt spreaders, but RCRK 10 may further be configured to control certain vehicle functions. For example, apparatus communicator 200 may be connected to the vehicle electrical system to control the 4x4 transmission, horn, emergency lights, headlights, etc. Also, apparatus communicator 200 may be connected to a GPS system that can log and store route information to confirm time, date and location of service performed. Alternatively, a GPS system may integrated into apparatus communicator 200.

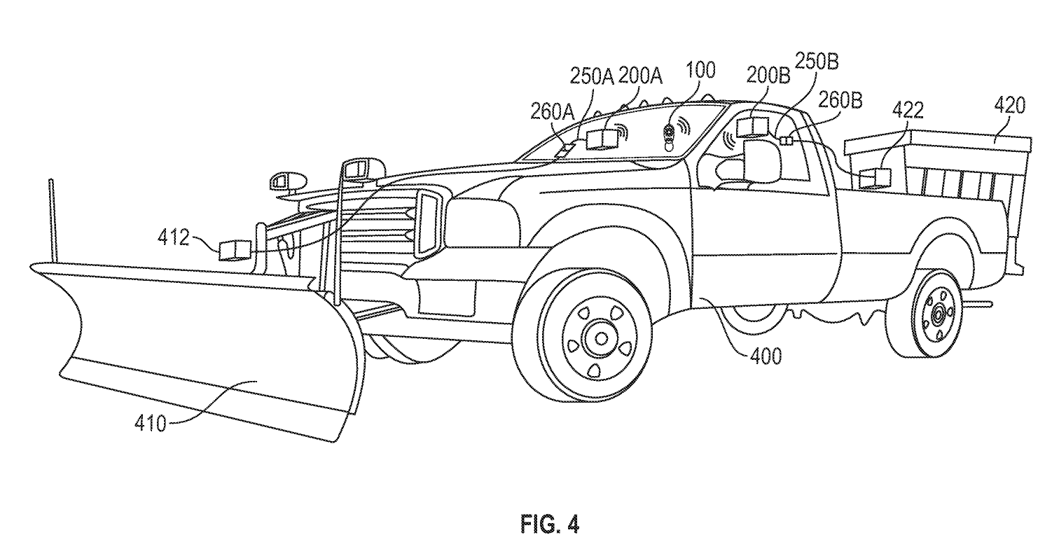

In the embodiment of FIG. 4, RCRK 10 comprises remote control 100 configured to control more than one vehicle-mounted apparatus. For example, remote control 100 may be configured to control both a snowplow and a salt spreader mounted on the same vehicle. In certain situations, RCRK 10 may comprise a single apparatus communicator 200 configured to control a snowplow or a single apparatus communicator 200 configured to control a salt spreader. In other situations, RCRK 10 may comprise multiple apparatus communicators 200A, 200B configured to control multiple vehicle-mounted apparatus. For example, RCRK 10 may comprise a first apparatus communicator 200A configured to control a snow plow and a second apparatus communicator 200B configured to control a salt spreader. FIG. 4 illustrates such an embodiment, where RCRK 10 comprises a remote control 100, a first apparatus communicator 200A configured to connect to the OEM wiring harness of a controller 412 for a first vehicle-mounted apparatus 410 (e.g., snow plow), a second apparatus communicator 200B configured to connect to the OEM wiring harness of controller 422 for a second vehicle-mounted apparatus 420 (e.g., salt spreader) and a remote control charger 300. Although RCRK 10 is herein described in connection with the operation of certain types of snow plows and salt spreaders, it should be understood that RCRK 10 may be configured to operate with different types of machines that may benefit from wireless control, such as for example, stone slingers or compactors. Further, although the embodiment comprising multiple apparatus communicators is described with reference to two different apparatus communicators (e.g., snow plow and salt spreader), it should be noted that RCRK 10 may comprise more than two apparatus communicators 200 controlled by a single remote control 100.

In some embodiments, wireless transmitter 140 of remote control 100 and wireless receiver 220 of apparatus communicator 200 are instead transceivers to allow two-way communication between remote control 100 and apparatus communicator 200. For the purposes of the present application, a “transceiver” should be interpreted as a combined transmitter and receiver unit that is configured to both generate and receive wireless signals. In one embodiment, remote control 100 and apparatus communicator 200 provide a remote control finder function. For example, apparatus communicator 200 may comprise a finder button that can be actuated so that microprocessor 230 generates a locator signal that is wirelessly transmitted by wireless transceiver 220 and antenna 210. When the locator signal is received by wireless transceiver 140 and antenna 150 of remote control 100, microprocessor 130 processes the locator signal to generate an audible tone via an integrated speaker, a visual indication via an integrated light, and/or haptic feedback via an integrated vibrating element.

In some embodiments, apparatus communicator 200 generates an operational status signal corresponding to an operational status of the apparatus that is wirelessly transmitted by wireless transceiver 220 and antenna 210. When the operational status signal is received by wireless transceiver 140 and antenna 150 of remote control 100, microprocessor 130 processes the operational status signal to generate an audible tone via an integrated speaker and/or a visual indication via an integrated light. Also, the integrated speaker in remote control 100 may be used to generate an audible tone as feedback to let a user know that an input element 110 has been activated. Different tones may be used for different input elements 110 corresponding to different apparatus functions. The integrated speaker of remote control 100 is configured to emit different snowplow direction and attitude tones depending on input element 100 that is activated. For example, remote control 100 may be configured to emit a plow raise tone when the plow raise input element 110a is actuated and a plow lower tone when the plow lower input element 110b is actuated. Similarly, remote control 100 may be configured to emit an attitude left tone when the pivot left input element 100c is actuated and an attitude right tone when the pivot right input element 110d is actuated. The tones may have distinct sounds such that they are distinguishable by ordinary human hearing. Remote control 100 may be configured to emit the snowplow direction and attitude tones for a predetermined amount of time after an input element 110 has been actuated. Alternatively, the controller may be configured to emit the snowplow direction and attitude tones throughout the duration of actuation of an input element 110.

In some embodiments, the second apparatus communicator 200B for controlling a salt spreader is connected to an outdoor temperature sensor, so that the outdoor temperature can be displayed to the user via display on the apparatus communicator 200B and aid the user in determining the amount of salt to apply. Additionally, the second apparatus communicator 200B for controlling a salt spreader may be configured to provide audio and visual indications of the status of the salt spreader. For example, the second apparatus communicator 200B may comprise visual indicators representing a speed of the conveyor, speed of the spinner, ON/OFF status of the vibrator, fuel tank level, jam indication, etc. Additionally, the second apparatus communicator 200B may comprise an integrated speaker for providing distinct audible tones in response to the activation/deactivation of different salt spreader functions and audible alarms in response to a jam condition, low salt level, low fuel level, etc.

FIG. 4 shows a motor vehicle 400 outfitted with a snowplow 410, a salt spreader 420 and a RCRK 10. RCRK 10 comprises a remote control 100, a first apparatus communicator 200A configured to connect to the OEM wiring harness of a controller 412 for a first vehicle-mounted apparatus 410 (e.g., snow plow), a second apparatus communicator 200B configured to connect to the OEM wiring harness of controller 422 for a second vehicle-mounted apparatus 420 (e.g., salt spreader) and a remote control charger 300. The snowplow 410 comprises a controller 412 that has OEM wiring harness 414 with a connector 416. The connector 260A at the end of cord 250B of the first apparatus communicator 200A is configured to connect to the connector 416 at the end of the OEM wiring harness 414 of the controller 412 for the snowplow 410. The salt spreader 420 comprises a controller 422 that has OEM wiring harness 424 with a connector 426. The connector 260B at the end of cord 250B of the first apparatus communicator 200A is configured to connect to the connector 426 at the end of the OEM wiring harness 424 of the controller 422 for the salt spreader 420.

Advantageously, a RCRK 10 according to present application retrofitting of existing vehicle-mounted apparatus for wireless control. Wireless control of a vehicle-mounted apparatus allows a person to troubleshoot a broken or malfunctioning vehicle-mounted apparatus while standing outside the vehicle and while being able to inspect the vehicle-mounted apparatus during operation. RCRK 10 may advantageously be fitted with apparatus of many different sizes, types and/or brands (e.g., snow plows, salt spreaders, mounted back blades, etc.). For example, RCRK 10 may be installed with a salt distributor that is operated by an electric motor or gasoline engine. Thus, a RCRK 10 according to the present application may advantageously be used as a near universal solution to retrofit a great number of machinery not originally manufactured for wireless remote control. The RCRKs 10 according to the present application may be fitted to various apparatus, including without limitation, snow plows, v-plows, wideout plows, bed salt distributors, tailgate salt distributors, dump trucks, plow trucks, skid steers, loaders, stone slingers compactors and municipal plows. While the present application has been illustrated and described with respect to particular embodiments thereof, it should be appreciated by those of ordinary skill in the art that various modifications to this disclosure may be made without departing from the spirit and scope of the present application.

What is claimed is:

1. A remote control retrofit kit for controlling a vehicle-mounted apparatus, comprising:
a remote control comprising a plurality of input elements for controlling the operation of the vehicle-mounted apparatus and a wireless transmitter; and
an apparatus communicator comprising a wireless receiver and a first cord with a first connector configured to connect to an OEM wiring harness of a controller of the vehicle-mounted apparatus;
wherein the wireless receiver of the apparatus communicator receives wireless signals corresponding to different apparatus operations from the wireless transmitter of the remote control and sends control signals to the controller of the vehicle-mounted apparatus to execute desired apparatus operations.

2. The remote control retrofit kit according to claim 1, wherein the wireless transmitter of the remote control and the wireless receiver of the apparatus communicator are configured to communicate using short-range unlicensed radio-frequency (RF) bands.

3. The remote control retrofit kit according to claim 1, wherein the remote control further comprises a flashlight.

4. The remote control retrofit kit according to claim 1, wherein the remote control further comprises an integrated microphone and a communication module implementing a communication protocol for communicating with a two-way radio, so that remote control can be used as a wireless handheld microphone for a two-way radio.

5. The remote control retrofit kit according to claim 1, further comprising a wiring harness adapter having a second cord with a plurality of wires, a second connector on one end of the cord and a plurality of third connectors attached to the plurality of wires on the other end of the second cord;
wherein the second connector of the wiring harness adapter is configured to mate and connect with the first connector of the apparatus communicator; and
wherein the plurality of third connectors of the wiring harness adapter are configured to connect directly with the controller of the vehicle-mounted apparatus.

6. The remote control retrofit kit according to claim 1, further comprising a remote control charger comprising a first power connector configured to be inserted into an electrical power receptacle in the vehicle and a second power connector configured to connect to a power input of the remote control for charging a rechargeable battery of the remote control.

7. The remote control retrofit kit according to claim 6, wherein the remote control charger further comprises a drop-in charging cradle;
wherein the second power connector is integrally provided in the charging cradle as electrical contacts that are adapted to abut corresponding electrical contacts of the power input of the remote control when the remote control is seated in the charging cradle.

8. The remote control retrofit kit according to claim 1, wherein the apparatus communicator further comprises a finder button that can be actuated to generate a locator signal that is wirelessly transmitted to the remote control; and
wherein the remote control further comprises a speaker and/or vibrating element for providing an audible tone and/or haptic feedback when the locator signal is received.

9. A remote control retrofit kit for controlling multiple vehicle-mounted apparatuses, comprising:
a remote control comprising a plurality of input elements for controlling the operation of the vehicle-mounted apparatus, a rechargeable battery, a power input and a wireless transmitter;
a remote control charger comprising a first power connector configured to be inserted into an electrical power receptacle in the vehicle and a second power connector configured to connect to the power input of the remote control for charging the rechargeable battery;
a first apparatus communicator comprising a first wireless receiver and a first cord with a first connector configured to connect to a first OEM wiring harness of a first controller of a first vehicle-mounted apparatus;
wherein the first wireless receiver of the first apparatus communicator receives wireless signals corresponding to different apparatus operations from the wireless transmitter of the remote control and sends control signals to the first controller of the first vehicle-mounted apparatus to execute desired apparatus operations; and
a second apparatus communicator comprising a second wireless receiver and a second cord with a second connector configured to connect to a second OEM wiring harness of a second controller of a second vehicle-mounted apparatus;
wherein the second wireless receiver of the second apparatus communicator receives wireless signals corresponding to different apparatus operations from the wireless transmitter of the remote control and sends control signals to the second controller of the second vehicle-mounted apparatus to execute desired apparatus operations.

10. The remote control retrofit kit according to claim 9, wherein the wireless transmitter of the remote control is configured to communicate with the first wireless receiver of the first apparatus communicator and the second wireless receiver of the second apparatus communicator using short-range unlicensed radio-frequency (RF) bands.

11. The remote control retrofit kit according to claim 9, wherein the remote control charger further comprises a drop-in charging cradle;
wherein the second power connector is integrally provided in the charging cradle as electrical contacts that are adapted to abut corresponding electrical contacts of the power input of the remote control when the remote control is seated in the charging cradle.

12. The remote control retrofit kit according to claim 9, wherein the first apparatus communicator or the second apparatus communicator further comprises a finder button that can be actuated to generate a locator signal that is wirelessly transmitted to the remote control; and
wherein the remote control further comprises a speaker and/or vibrating element for providing an audible tone and/or haptic feedback when the locator signal is received.

13. A remote control retrofit kit for controlling a vehicle-mounted apparatus, comprising:
a remote control comprising a plurality of input elements for controlling the operation of the vehicle-mounted apparatus and a wireless transmitter;
a remote control charger comprising a first power connector configured to be inserted into an electrical power receptacle in the vehicle and a second power connector configured to connect to the power input of the remote control for charging the rechargeable battery;
an apparatus communicator comprising a wireless receiver and a first cord with a first connector; and
a wiring harness adapter having a second cord with a plurality of wires, a second connector on one end of the cord and a plurality of third connectors attached to the plurality of wires on the other end of the second cord;
wherein the second connector of the wiring harness adapter is configured to mate and connect with the first connector of the apparatus communicator;
wherein the plurality of third connectors of the wiring harness adapter are configured to connect directly with a controller of the vehicle-mounted apparatus; and
wherein the wireless receiver of the apparatus communicator receives wireless signals corresponding to different apparatus operations from the wireless transmitter of the remote control and sends control signals to the controller of the vehicle-mounted apparatus to execute desired apparatus operations.

14. The remote control retrofit kit according to claim 13, wherein the wireless transmitter of the remote control and the wireless receiver of the apparatus communicator are configured to communicate using short-range unlicensed radio-frequency (RF) bands.

15. The remote control retrofit kit according to claim 13, wherein the remote control further comprises a flashlight.

16. The remote control retrofit kit according to claim 13, wherein the remote control further comprises an integrated microphone and a communication module implementing a communication protocol for communicating with a two-way radio, so that remote control can be used as a wireless handheld microphone for a two-way radio.

17. The remote control retrofit kit according to claim 13, wherein the remote control charger further comprises a drop-in charging cradle;
wherein the second power connector is integrally provided in the charging cradle as electrical contacts that are adapted to abut corresponding electrical contacts of the power input of the remote control when the remote control is seated in the charging cradle.

18. The remote control retrofit kit according to claim 13, wherein the apparatus communicator further comprises a finder button that can be actuated to generate a locator signal that is wirelessly transmitted to the remote control; and
wherein the remote control further comprises a speaker and/or vibrating element for providing an audible tone and/or haptic feedback when the locator signal is received.
